(19) United States
(12) Patent Application Publication
(10) Pub. No.: US 2013/0163905 A1
(43) Pub. Date: Jun. 27, 2013

(54) HIGH-CYCLE, SHORT RANGE-OF-MOTION LINKAGE APPARATUS FOR GAS TURBINE ENGINE APPLICATIONS

(71) Applicant: Roller Bearing Company of America, Inc., Oxford, CT (US)

(72) Inventors: Sean Vintinner, Tustin, CA (US); Samuel A. Nunn, Lake Forest, CA (US)

(73) Assignee: ROLLER BEARING COMPANY OF AMERICA, INC., Oxford, CT (US)

(21) Appl. No.: 13/707,166

(22) Filed: Dec. 6, 2012

Related U.S. Application Data
(60) Provisional application No. 61/567,318, filed on Dec. 6, 2011.

(51) Int. Cl. F16C 33/04

(52) U.S. Cl. CPC F16C 33/04
USPC 384/155

(57) ABSTRACT

A high-cycle, short range-of-motion linkage apparatus is provided for actuation of a positioning device. The linkage apparatus includes a pivot member having a stem extending therefrom, a positioning member including a receiving portion into which the stem is removably secured, and at least one spherical plain bearing secured to the pivot member. The spherical plain bearing has an inner member having an outer engagement surface and a bore extending at least partway therethrough, an outer member positioned at least partially around the inner member, the outer member having an inner engagement surface contoured to a shape complementary to the outer engagement surface of the inner member, and a liner disposed between the inner engagement surface of the outer member and the outer engagement surface of the inner member, the liner comprising polytetrafluoroethylene and a phenolic resin reinforced with aramid fibers.

### CROSS-REFERENCE TO RELATED APPLICATION

This application claims the benefit of U.S. Provisional Patent Application Ser. No. 61/567,318; filed on Dec. 6, 2011, which is incorporated herein by reference in its entirety.

### TECHNICAL FIELD

The present invention is directed to bearings and, more particularly, to swaged self-lubricating bearings for use in high-cycle, short range-of-motion linkages for gas turbine engines.

### BACKGROUND

Spherical plain bearings typically comprise a ball positioned for rotational movement in an outer race. The outer race defines an inner surface contoured to receive and retain the ball therein. In one type of spherical plain bearing, the outer race is swaged around the spherical outer surface of the ball. In some cases, particularly those in which the ball and the outer race are each metallic and in which there is metal-on-metal contact, however, the outer race may be constructed with a slot to permit insertion of the ball. Such bearings are referred to as “load slot bearings.”

Bearings in which there is metal-on-metal contact are generally used in environments in which marked variations in pressure, temperature, and high frequency vibrations are experienced. However, such variations in pressure, temperature, and high frequency vibrations can result in the bearings exhibiting high levels of wear. Moreover, high-cycle metal-on-metal contact or engagement within a short range-of-motion exacerbates the high levels of wear. Also, in these environments, foreign objects can impinge on the bearings, and contaminants such as dust, dirt, water, and aerospace fluids can be encountered, all of which can contribute to bearing wear. Additionally, high temperatures and pressures can cause severe oxidation or other forms of corrosion on the metal surfaces. Worn and oxidized bearings generate significant increases in friction and overload the interfacing hardware, which can lead to low cycle fatigue (LCF) stress problems where the interfacing hardware can also fail.

### SUMMARY

In one aspect, the present invention resides in a spherical plain bearing assembly comprising a ball and an outer race positioned at least partially around an outer engagement surface of the ball. The outer race has an inner engagement surface contoured to a shape complementary to the outer surface of the ball. A lubricous liner is disposed on the inner engagement surface of the outer race, the lubricious liner comprising polytetrafluoroethylene and a phenolic resin reinforced with aramid fibers. The outer engagement surface of the ball is slidably and rotatably engaged with the inner engagement surface.

In another aspect, the present invention resides in a high-cycle, short range-of-motion linkage apparatus for actuation of a positioning device. The linkage apparatus includes a pivot member having a stem extending therefrom, a positioning member including a receiving portion into which the stem is removably secured, and at least one spherical plain bearing secured to the pivot member. The spherical plain bearing has an inner member having an outer engagement surface and a bore extending at least partway therethrough, an outer member positioned at least partially around the inner member, the outer member having an inner engagement surface contoured to a shape complementary to the outer engagement surface of the inner member, and a liner disposed between the inner engagement surface of the outer member and the outer engagement surface of the inner member, the liner comprising polytetrafluoroethylene and a phenolic resin reinforced with aramid fibers.

### BRIEF DESCRIPTION OF THE DRAWINGS

FIG. 1 is a side cross-sectional view of a bearing of the present invention.

FIG. 2 is a side cross-sectional view of a linkage apparatus of the present invention into which the bearing of FIG. 1 is mounted.

FIG. 3 is an exploded perspective view of one embodiment of mounting the linkage apparatus of FIG. 2 to a structural member.

FIG. 4 is a side cross-sectional view of one embodiment of the linkage apparatus of FIG. 2 into which the bearing of FIG. 1 is mounted into a first end and a second end of the linkage apparatus.

FIG. 5 is a side cross-sectional view of another embodiment of the linkage apparatus of FIG. 2 comprising a pneumatic actuator.

FIG. 6A is a perspective view of one embodiment of a positioning member of the present invention, namely, a linkage extension, which is engaged by the linkage apparatus of FIG. 2.

FIG. 6B is a top plan view of another embodiment of a positioning member of the present invention, namely, a turbofan engine variable stator vane actuator ring assembly, which is engaged by two of the linkage apparatuses of FIG. 2.

FIG. 6C is a perspective view of another embodiment of a positioning member of the present invention, namely, a turbofan engine variable bypass valve assembly, which is engaged by the linkage apparatus of FIG. 2.

FIG. 7 is an exploded perspective view of another embodiment of a positioning member of the present invention, namely, a turbofan engine component case, which is engaged by the linkage apparatus of FIG. 2.

FIG. 8 is an exploded perspective view of another embodiment of a turbofan engine component case which is engaged by two of the linkage apparatuses of FIG. 2.

FIG. 9 is a perspective view of a variable exhaust nozzle for an afterburner on a turbofan engine, the variable exhaust nozzle comprising a plurality of the linkage apparatuses of FIG. 2 and FIG. 4.

FIG. 10 is an exploded perspective view of a plate and the plurality of linkage apparatuses of the variable exhaust nozzle of FIG. 9.

### DETAILED DESCRIPTION

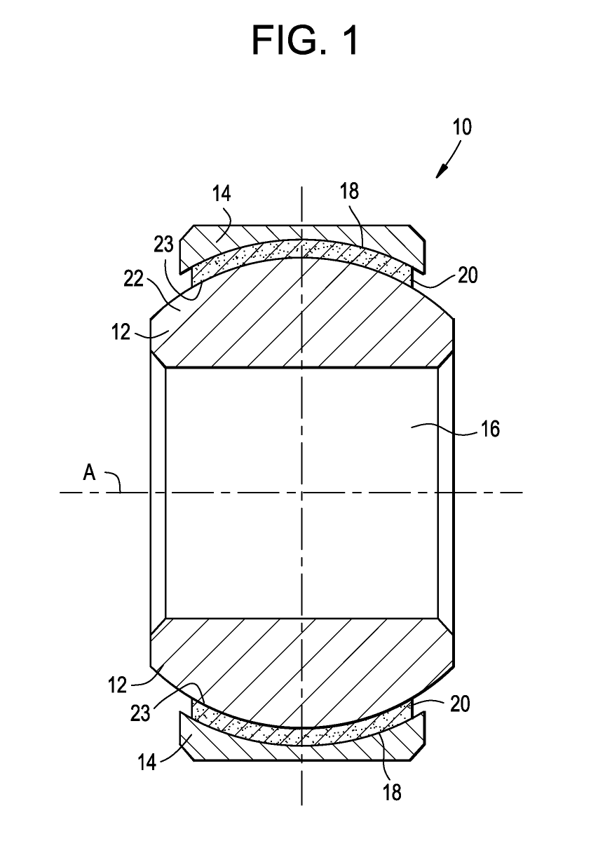

As shown in FIG. 1, a spherical plain bearing assembly of a swaged configuration is designated generally by the reference number 10 and is hereinafter referred to “bearing assembly 10.” Bearing assembly 10 includes an inner member or a ball 12 positioned in an outer member or an outer race 14. A central axis A is defined through the bearing assembly 10. The ball 12 defines an outer surface 22, a portion of which is an outer engagement surface 23. The ball 12 further defines a bore 16 extending therethrough and adapted to receive a portion of a shaft or other component therein. The present invention is not so limited, as the ball 12 may be integral with or form part of a shaft or other component. Moreover, while the bore 16 is shown and described as extending through the ball 12, the present invention is not limited in this regard as the bore can extend part-way through the ball, the bore may define a stepped-bore, or the ball may not define a bore without departing from the broader aspects of the invention.

In the illustrated embodiment, the outer race 14 is a ring having an inner surface, a portion of which is an inner engagement surface 18 on which a self-lubricating liner 20 is disposed. The inner engagement surface 18 is contoured to a shape complementary to the outer engagement surface 23 of the ball 12. As shown, at least a portion of the inner engagement surface 18 is concave, and at least a portion of the outer surface of the ball is convex. When the ball 12 is located in the outer race 14, the outer surface 22 engages the liner 20. While the outer race 14 has been shown and described as being a ring, the present invention is not limited in this regard as the outer race can assume any practical shape or be part of another component, such as, for example a housing, without departing from the broader aspects of the invention.

The ball 12 is made from any suitable material, such as metal or alloys. Suitable metals and alloys from which the ball 12 may be fabricated include, but are not limited to, stainless steels (e.g., 440C, A286, and the like), nickel-chromium-based superalloys (e.g., Inconel and the like), titanium, titanium alloys, silicon nitride, silicon carbide, zirconium, and the like.

The outer race 14 is made from any suitable material, such as metal or alloys. Suitable metals from which the outer race 14 may be fabricated include, but are not limited to, stainless steels (e.g., 17-4 PH® stainless steel), titanium, titanium alloys, and the like. The present invention is not so limited, however, as ceramics may be used in the construction of the outer race 14.

The liner 20 on the inner engagement surface 18 comprises a polytetrafluoroethylene (“PTFE”) and a phenolic resin reinforced with aramid fibers. More particularly, the liner 20 comprises PTFE and a layer of low-friction material, namely, a phenolic resin reinforced with aramid fibers (such as Nomex®, available from E. I. du Pont de Nemours and Company, Wilmington, Del.). The fiber may comprise a plain, twill or satin weave. The present invention is not limited to the use of aramid fibers, however, as other fibers including, but not limited to, glass, polyester, glass woven with Teflon®, and carbon fibers are within the scope of the present invention. The use of PTFE and phenolic resin reinforced with aramid fibers provides for toughness, high wear resistance, and protection against dynamic, high frequency vibratory loads.

The liner 20 is suited for use in moderate to high temperature environments and is particularly suited for use in turbofan engines. The resin used to formulate the liner 20 could be phenolic for moderate temperature applications in the range of about 300° F. to about 500° F., and polyimide for higher temperature applications in the range of about 500° F. to about 600° F. For lower temperature applications up to about 350° F., the liner 20 may be fabricated as a homogenous machinable liner formulated from a curable acrylate composition with various fillers for structure and PTFE for lubrication. The liner 20, however, is not limited to PTFE and a phenolic resin reinforced with aramid fibers and may comprise other material(s) suitable for use in the moderate to high temperature environments in which the bearing assembly 10 is to be used. Other liners that may be used include, but are not limited to, those with different fabric reinforcements, machinable materials (for example, materials without fabric reinforcement but with other reinforcement structures), and other self-lubricating materials that may include polyimide resins. Additionally, the liner 20 could be attached to supporting structure without the outer race 14.

During operation of the bearing assembly 10, the liner 20 on the inner engagement surface 18 of the outer race 14 engages the outer engagement surface 23 of the ball 12, thereby causing the ball 12 to move slidably and rotatably relative to the outer race 14. The liner 20 is particularly suited for high-cycle engagement within a short range-of-motion. A high-cycle angular range-of-motion of the outer race 14 in relation to the ball 12 can range from 0° up to 90°, 270° and 360°. In particular, such high-cycle angular range-of-motion can range from about 15° to about 45°. More particularly, such high-cycle angular range-of-motion can range from about 5° to about 10°. Accordingly, the bearing assembly 10 is particularly suited for high-cycle engagement within a short range-of-motion for moderate temperature applications in the range of about 300° F. to about 500° F., and for higher temperature applications in the range of about 500° F. to about 600° F.

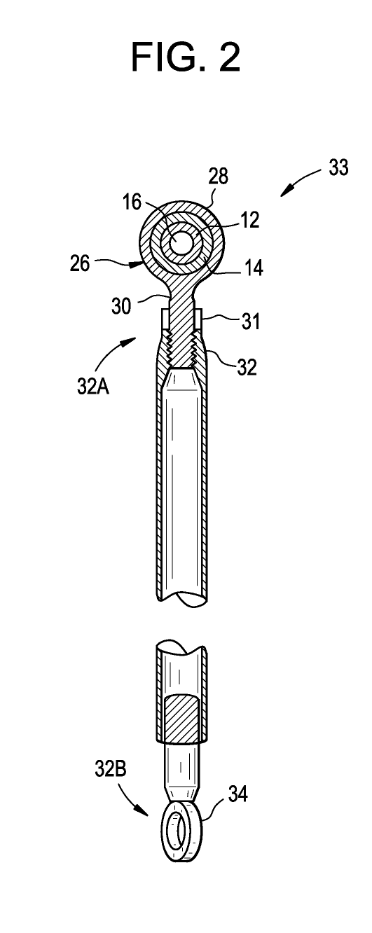

As shown in FIG. 2, the outer race 14 is swaged around the ball 12, one of which has the liner 20 disposed thereon, for example, by swaging the bearing assembly 10 into a pivot member or socket 26 for use in aircraft, aerospace, heavy equipment, or vehicular applications. The socket 26 has a head portion 28 and a neck or stem 30 extending therefrom that is removably secured or threadedly received in a receiving portion 31 of a positioning member 32, moveable between at least a first position and a second position and thereby defining a linkage apparatus 33. The positioning member 32 defines a first end 32A defining the receiver portion 31 into which the stem 30 is removably secured, and a second end 32B defining a coupling member 34 for coupling the position member 32 to a structural member 29 or the like as further described below. The coupling member 34 may be press fit into second end 32B of the positioning member 32. Although the coupling member 34 has been described as being press fit into the second end 32B of the positioning member 32, other methods for securing the coupling member 34 within the second end 32B of the positioning member 32, such as, for example, by threaded engagement, pins and corresponding apertures and other like fastening means, or by cooling the coupling member 34 and heating the coupling member 34, are considered within the scope of the invention.

The link apparatus 33 is especially suitable for use in pneumatic actuators, variable geometry systems, and as support links for accessories. In addition, the link apparatus 33 is particularly suitable as a high-cycle, short range-of-motion linkage apparatus for actuation of one or more positioning devices. Said positioning devices particularly include turbofan engine component linkages, such as, for example, a turbofan engine component case, a variable stator vane (“VSV”) actuator ring assembly, and a variable exhaust nozzle for an afterburner or augmentor on a turbofan engine. The present invention is not limited in this regard, as the link apparatus 33 may be used in other applications as described below.

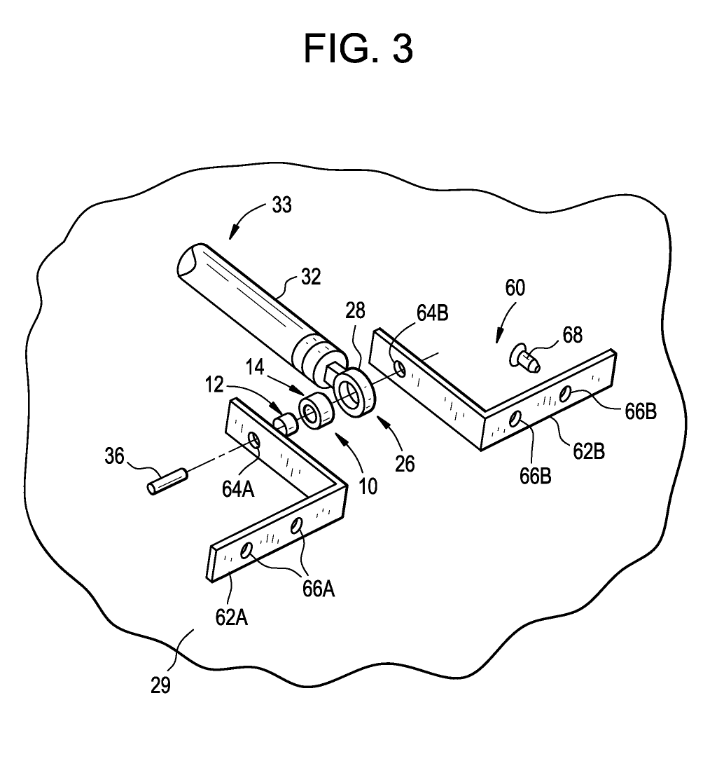

As shown in FIG. 3, one embodiment of mounting the linkage apparatus 33 to the structural member 29 includes coupling the linkage apparatus 33 to a mounting assembly 60 that is, in turn, removeably and securely fastened to the structural member 29. The ball 12 and the outer race 14 of the bearing assembly 10, one of which has the liner 20 disposed thereon, is swaging into the head portion 28 of the socket 26. The bearing assembly 10 is pivotally connected to a pair of mounting brackets 62A and 62B via a shaft or pin 36 extending through the bearing assembly 10. The pin 36 is secured in the bore 16 of the bearing assembly 10 and a pair of apertures 64A and 64B defined respectively in the mounting brackets 62A and 62B via a press fit. The press fit, also known as an interference fit or friction fit, is maintained by friction after the pin 36 has been pushed or driven into the bore 16 and the apertures 64A and 64B by a process such as staking. In one embodiment, the pin 36 is slightly undersized thereby creating an initial slip fit within the bore 16 and the apertures 64A and 64B. A staking punch is then used to compress the pin 36 radially and thereby form the press fit or interference fit between the pin 36 and the bore 16 and the apertures 64A and 64B. The press fit relies upon the tensile and compressive strengths of the materials from which the respective parts are fabricated. Although the pin 36 has been described as being press fit or staked into the bore 16 and the apertures 64A and 64B, other methods for engaging the pin 36 within the bore 16 and the apertures 64A and 64B, for example, by cooling the pin 36 and heating the bore 16 and the apertures 64A and 64B, are considered within the scope of the invention. In addition, the pin 36 may be integrally formed with the ball 12.

Each of the mounting brackets 62A and 62B are removeably and securely fastened to the structural member 29 by fasteners 68 (only one fastener 68 shown) threadedly received within correspondingly tapped apertures (not shown) in the structural member 29. The present invention is not limited in this regard as the fasteners 68 may comprise a pin that is press fit into corresponding apertures in the structural member 29, the press fit being as described hereinabove with respect to the pin 36, the bore 16 and the apertures 64A and 64B. While fasteners 68 are shown and described for removeably and securely fastening the mounting brackets 62A and 62B to the structural member 29, the present invention is not limited in this regard as the mounting brackets 62A and 62B may be fixedly connected to the structural member 29 by any number of material joining means, such as, for example, use of suitable adhesives, welding, or being integrally forged or cast therewith, may also be employed without departing from the broader aspects of the invention.

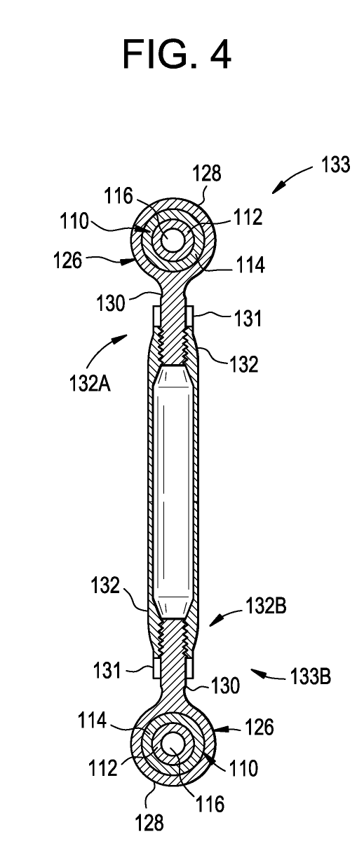

A linkage apparatus 133 is depicted in FIG. 4 and is similar to the linkage apparatus 33 shown in FIG. 2, thus like elements are given a like element number preceded by the numeral 1.

As shown in FIG. 4, the linkage apparatus 133 comprises a positioning member 132 that defines a first end 132A and a second end 132B. Both the first and second ends 132A and 132B of the positioning member 132 each comprise a pivot member or socket 126 having a head portion 128 and a stem 130 extending therefrom that is removably secured or threadedly received in a receiving portion 131 of the positioning member 132. Each of the sockets 126 have a bearing assembly 110 swaged therein, each of the bearing assemblies 110 comprising a ball 112 defining a bore 116 therethrough, an outer race 114 and a liner (not shown) disposed between the ball 112 and the outer race 114. Thus, the linkage apparatus 133 comprises bearing assemblies 110 swaged into sockets 126 at a first end 133A and a second end 133B of the linkage apparatus 133.

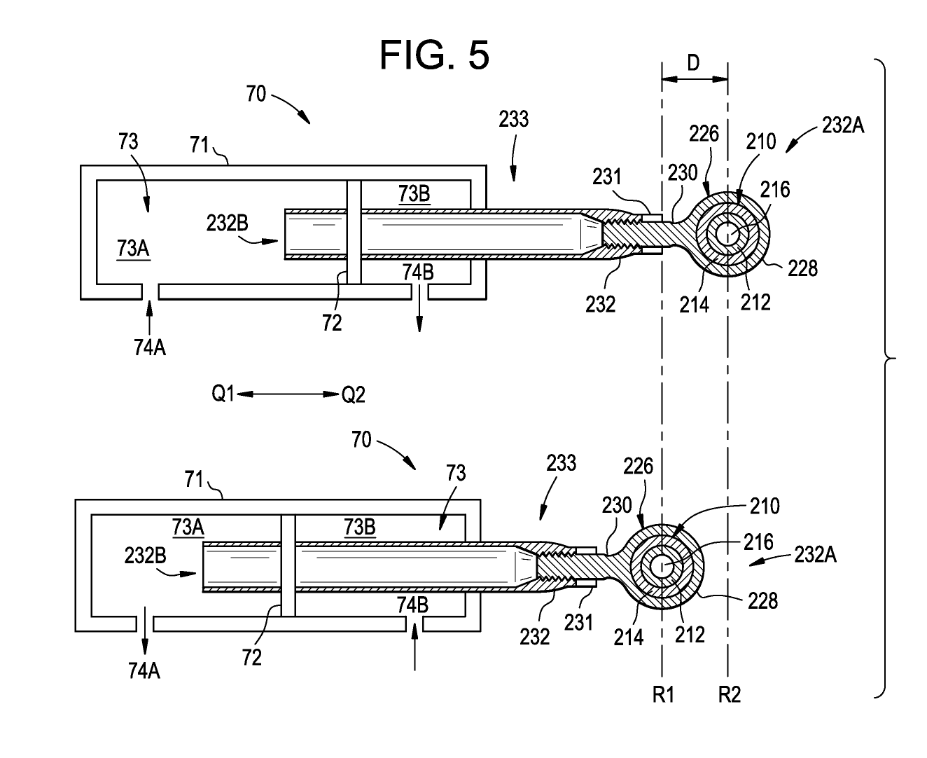

A linkage apparatus 233 for actuation of a positioning device is depicted in FIG. 5 and is similar to the linkage apparatus 33 shown in FIG. 2, thus like elements are given a like element number preceded by the numeral 2.

The linkage apparatus 233 depicted in FIG. 5 comprises an actuator such as, for example, a pneumatic actuator 70, that is shown in a retracted position R1 and an extended position R2. The actuator 70 comprises an actuator housing 71 and the linkage apparatus 233 comprises a positioning member 232 that defines a first end 232A and a second end 232B. The first end 232A of the positioning member 232 comprises a pivot member or socket 226 having a head portion 228 and a stem 230 extending therefrom that is removably secured or threadedly received in a receiving portion 231 of the positioning member 232. The socket 226 has a bearing assembly 210 swaged therein comprising a ball 212 defining a bore 216 therethrough, an outer race 214 and a liner (not shown) disposed between the ball 212 and the outer race 214.

The second end 232B of the linkage apparatus 233 is fixedly secured to a moveable block, plunger or piston 72 of the actuator 70 for actuation of the positioning device (not shown). The piston 72 divides an interior volume 73 of the actuator housing 71 into a first interior volume 73A and a second interior volume 73B. The actuator housing 71 is fitted within a vessel or a cylinder (not shown) in which a hydraulic fluid is in communication with the interior volume 73 of the actuator housing 71. The actuation of the positioning device is initiated when the piston 72 and the linkage apparatus 233 is in the retracted position R1.

In operation, the hydraulic fluid is pumped into the first interior volume 73A via a port 74A formed in the housing 71, at a Pressure P1, and a corresponding amount of hydraulic fluid is released from the second interior volume 73B via a port 74B formed in the housing 71, at a Pressure P2 which is less than Pressure P1. The influx of the hydraulic fluid into the first interior volume 73A (and the corresponding release of hydraulic fluid from the second interior volume 73B) causes the piston 72 to advance in a direction indicated by the arrow Q2 thereby extending the linkage apparatus 233 in the direction Q2 such that the bearing assembly 210 advances a distance D in the direction Q2 thereby extending or actuating a positioning device. Similarly, the hydraulic fluid is pumped into the second interior volume 73B via the port 74BA, at a Pressure P1, and a corresponding amount of hydraulic fluid is released from the first interior volume 73A via the port 74A, at a Pressure P2 which is less than Pressure P1. The influx of the hydraulic fluid into the second interior volume 73B (and the corresponding release of hydraulic fluid from the first interior volume 73A) causes the piston 72 to retract in a direction indicated by the arrow Q1 thereby retracting the linkage apparatus 233 in the direction Q1 such that the bearing assembly 210 retracts the distance D in the direction Q1 thereby retracting or de-actuating the positioning device. The force that acts upon the positioning device is equal to the Pressure P1 of the hydraulic fluid pumped into the interior volume 73 of the housing 71 multiplied by the area of the piston 72. Accordingly, linkage apparatus 233 comprises the actuator 70 having a positioning member 232 that defines a shaft or socket 26 extending therefrom and is operable between the retracted condition or position R1 and the extended condition or position R2 to move the positioning 232 member between at least the position R1 and the position R2.

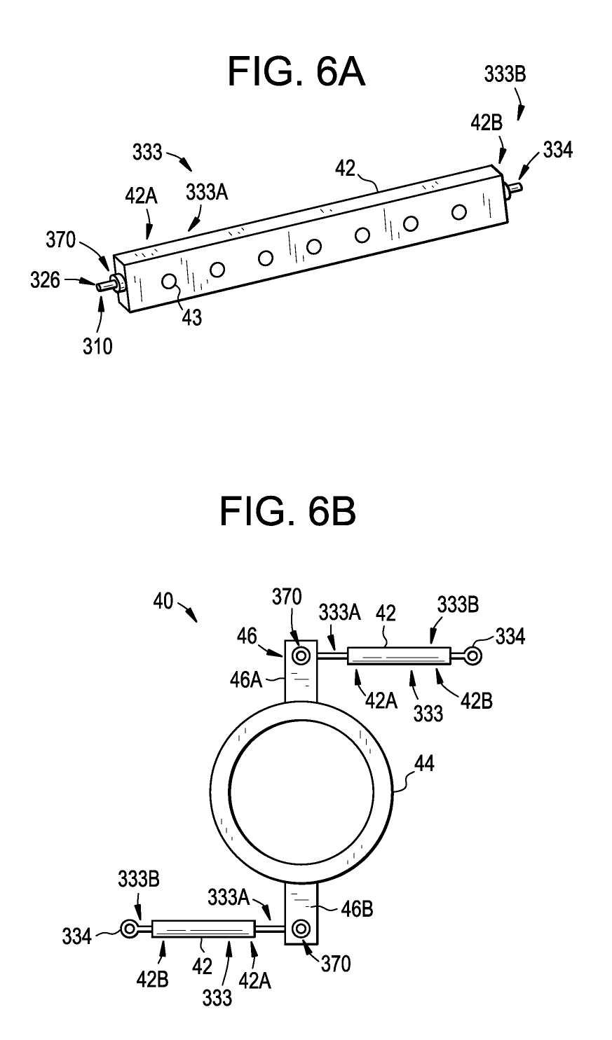

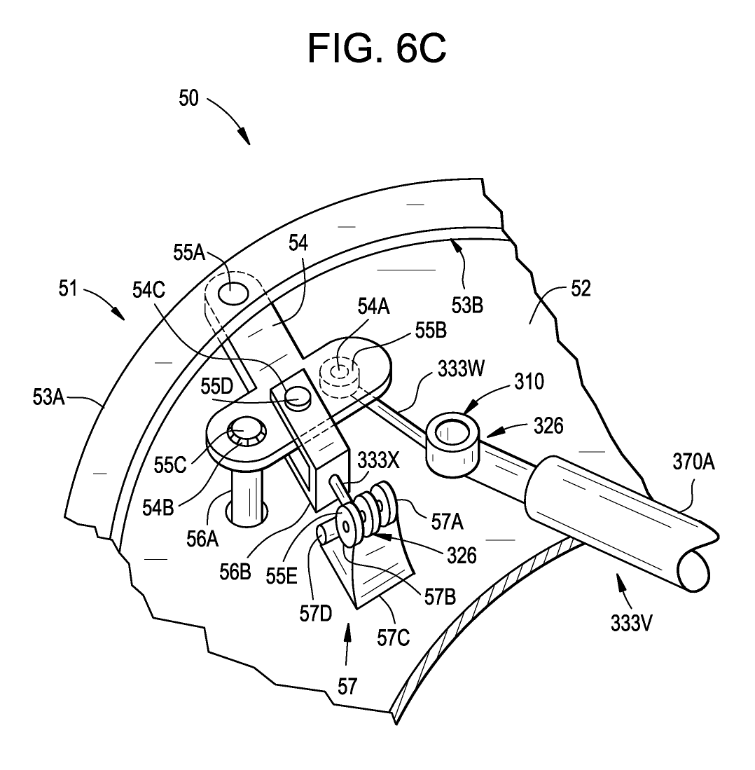

A linkage apparatus 333 for actuation of a positioning device is depicted in FIGS. 6A and 6B and is similar to the linkage apparatus 33 shown in FIG. 2, the linkage apparatus 133 shown in FIG. 4 and the actuator 70 shown in FIG. 5, thus like elements are given a like element number preceded by the numeral 3.

One variable geometry system in which the linkage apparatus 333 may be employed is a VSV actuator system for a turbofan engine as depicted in FIGS. 6A and 6B. The present invention is not limited to VSV actuator systems for turbofan engines, however, as linkage apparatus 333 may be employed in conjunction with rod ends, bell cranks, linkages, and the like in other systems including, but not limited to, crankshaft systems, systems for the control of bleed and/or bypass air, etc. In the VSV actuator system, a set of stator vanes internal to the engine is adjusted to obtain a smoother air flow through a compressor section of the turbofan engine.

The VSV actuator system is shown generally at 40 and is hereinafter referred to as “system 40.” System 40 comprises a positioning member or a bar 42 having a first end 42A and a second end 42B. A pneumatically operable actuator 370 is received within or fixedly attached to the first end 42A of the bar 42. The actuator 370 includes a socket 326 comprising a bearing assembly 310 as described above with reference to FIG. 5. A plurality of apertures 43 may be formed in the bar 42 for connecting one or more additional links (not shown) to the bar 42 wherein each link also may including a socket 326 comprising a bearing assembly 310. A coupling member 334 is received within or fixedly attached the second end 42B of the bar 42 for coupling the position member 32 to a structural member (not shown) as described hereinabove with reference to FIG. 3. The present invention is not so limited as the linkage apparatus 333 may define the linkage apparatus 133 depicted in FIG. 4 such that a second actuator (not shown) is received within or fixedly attached to the second end 42B of the bar 42.

Referring to FIG. 6B, system 40 further comprises an actuator ring 44 defining one or more flanges 46, flanges 46A and 46B as shown in FIG. 6B. The actuator 370 of a first end 333A of the linkage apparatus 333 is pivotally connected to each flange 46 as described above with reference to pivotally connecting the bearing assembly 10 to the mounting brackets 62A and 62B via a shaft or pin 36 extending through the bearing assembly 10, and the like, as depicted in FIG. 3. The coupling member 334 of a second end 333B of the linkage apparatus 333 is removeably and securely fastened to the structural member 350 as described above with reference to removeably and securely fastening the mounting brackets 62A and 62B to the structural member 29 by fasteners 68 threadedly received within correspondingly tapped apertures in the structural member 29, and the like, as depicted in FIG. 3. Upon operation of the actuator 370, the flange 46 and/or the actuator ring 44 is moved to adjust the stator vanes (not shown) in the turbofan engine. The bearing assemblies 310 in the sockets 326 allow for the desired operation of the system 40 at the temperatures encountered in the turbofan engine.

Another variable geometry system in which the linkage apparatus 333 may be employed is a variable bypass valve (“VBV”) assembly for a turbofan engine as depicted in FIG. 6C. The VBV assembly is shown generally at 50 and is hereinafter referred to as “system 50.” Along with the VSV actuator system, system 40, the VBV assembly, system 50, is employed to obtain a smoother air flow through a compressor section of the turbofan engine by allowing a specified amount of air to bypass a stator vane assembly or stage. Referring to FIG. 6C, system 50 further comprises a ring such as the actuator ring 44 (FIG. 6B), or another disc or ring 51, or like component of a stator vane assembly or stage. The ring 51 defines a base 52 that typically extends radially outward from a shaft (not shown) or other turbofan engine component that extends axially along a centreline of the turbofan engine. The ring 51 further defines a flange 53A along its radially inner facing periphery that defines an axially extending channel 53B. A first VBV linkage or T-bracket 54 is positioned within the channel 53B and is pivotally connected thereto via a fastener such as a pin 55A.

A linkage apparatus 333V comprises a pneumatically operable actuator 370A having a socket 326 and a bearing assembly 310, at a first end, as described above with reference to FIG. 5. The actuator 370A is pivotally connected to a second VBV linkage or a linkage apparatus 333W, at a first end, as described above with reference to pivotally connecting the bearing assembly 10 to the mounting brackets 62A and 62B via a shaft or pin 36 extending through the bearing assembly 10, and the like, as depicted in FIG. 3. The linkage apparatus 333V comprises, at a second or distal end, a coupling member (not shown) that is removeably and securely fastened to a structural member (not shown) as described above with reference to removeably and securely fastening the mounting brackets 62A and 62B to the structural member 29 by fasteners 68 threadedly received within correspondingly tapped apertures in the structural member 29, and the like, as depicted in FIG. 3.

The linkage apparatus 333W, at a second one end, is pivotally connected to a first aperture 54A defined in the T-bracket 54 via a fastener such as a pin 55B. A mount or shaft 56A extending upwardly from, or axially outward from, the base 52 the ring 51 is pivotally connected to a second aperture 54B defined in the T-bracket 54 via a fastener such as a pin 55C. A third VBV linkage or a clevis link 56B is pivotally connected to a third aperture 54D defined in the T-bracket 54 via a fastener such as a pin 55D. While the fastener employed with the VBV linkages are shown and described as a pins 55A, 55B, 55C and 55D, the present invention is not limited in this regard as one or more of the fasteners may define a bearing assembly 10, a spherical plain bearing without a liner, other bearing assemblies such as roller or needle bearings, or other pivotally mounted fasteners without departing from the broader aspects of the invention.

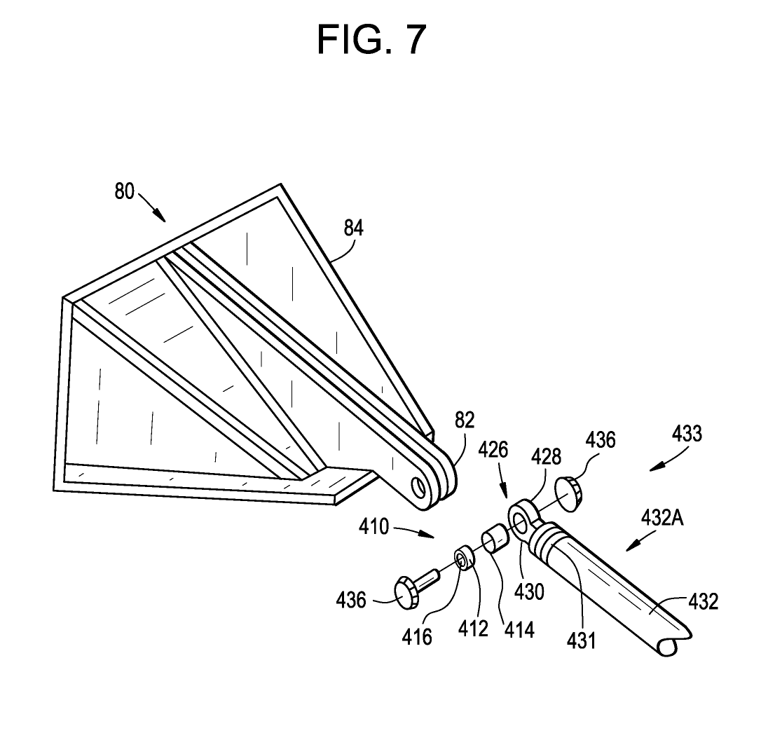

A linkage apparatus 333X extends from the clevis link 56B having a socket 326 and a bearing assembly of the present invention swaged therein. A shaft or pin 55E extends through the bearing assembly swaged into the socket 326 extending from the clevis link 56B and is pivotally connected to one or more rotatable socket-type joints 57A and 57B. Such socket-type joints 57A and 57B each may comprise a bearing assembly of the present invention swaged therein. A VBV door assembly 57 defines a door flap 57C rotatably connected on one side to the base 52 of the ring 51 via a hinged connection 57D. Upon operation of the actuator 370A, the T-bracket 54 rotates about pin 55A connecting the T-bracket 54 to the flange 53A, and in turn the linkage apparatus 333X extending from the clevis link 56B acts upon the VBV door assembly 57 such that it rotates upwardly, or axially outwardly, from the base 52 thereby exposing an opening or cavity in the base 52 through which bypass air will flow. The VBV assembly allows for the desired operation of the VBV door assembly 57 at the temperatures encountered in the turbofan engine by defining one of a partially open air flow condition and a closed air flow condition. A linkage apparatus 433 for actuation of a positioning device is depicted in FIG. 7 and is similar to the linkage apparatus 33 shown in FIG. 2, thus like elements are given a like element number preceded by the numeral 4.

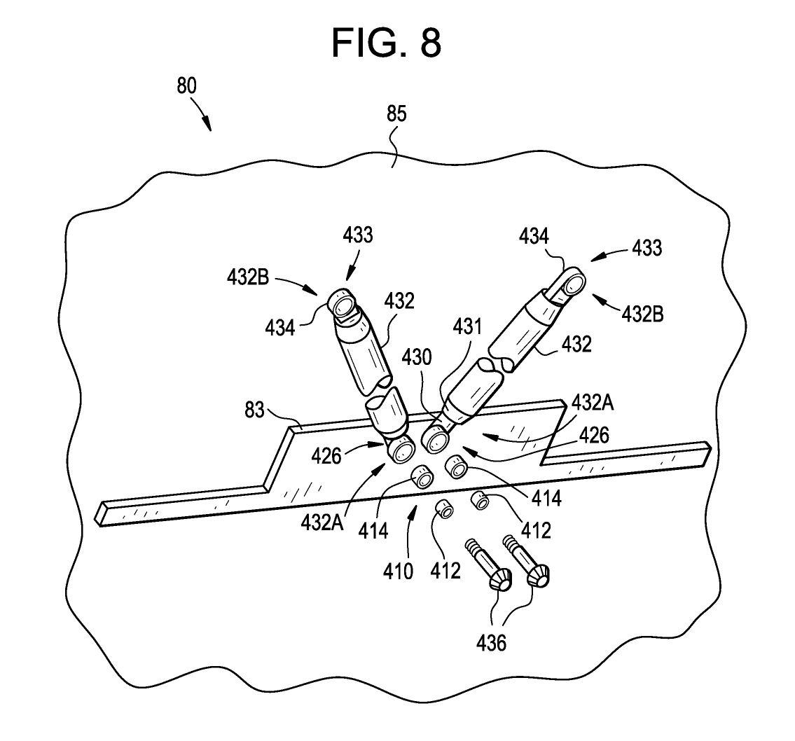

As shown in FIGS. 7 and 8, the linkage apparatus 433 comprises a positioning member 432 that defines a first end 432A and a second end 432B (shown in FIG. 8). The first end 432A of the positioning member 432 comprises a pivot member or socket 426 having a head portion 428 and a stem 430 extending therefrom that is removably secured or threadedly received in a receiving portion 431 of the positioning member 432. The socket 426 has a bearing assembly 410 swaged therein comprising a ball 412 defining a bore 416 therethrough, an outer race 414 and a liner (not shown) disposed between the ball 412 and the outer race 414. As shown in FIG. 7, the bearing assembly 410 of the linkage apparatus 433 is pivotally connected to a flange 82 fixedly attached to, or integrally formed with, and extending from a housing 84 of a turbofan engine component 80. As shown in FIG. 8, more than one linkage apparatus 433 can be independently coupled or pivotally connected to a flange 83 fixedly attached to, or integrally formed with, and extending from a housing 85 of the turbofan engine component 80. Said turbofan engine component 80 may comprise, for example, an oil cooler, and air cooler, or an integrated oil/air cooler.

The bearing assembly 410 is pivotally connected to the flange 82 or 83 via a shaft or pin 436 as described above with reference to pivotally connecting the bearing assembly 10 to the mounting brackets 62A and 62B via a shaft or pin 36 extending through the bearing assembly 10, and the like, as depicted in FIG. 3. A coupling member 434 (FIG. 8) or another socket (not shown) extends from the second end 433B of each of the linkage apparatuses 433 and is removeably and securely fastened to a structural member (not shown) as described above with reference to removeably and securely fastening the mounting brackets 62A and 62B to the structural member 29 by fasteners 68 threadedly received within correspondingly tapped apertures in the structural member 29, and the like, as depicted in FIG. 3. The bearing assembly 410 accommodates movement of the turbofan engine component 80 relative to other turbofan engine components during operation of the turbofan engine. Linkage apparatuses 433 incorporating sockets 426 and bearing assemblies 410 may be employed as link apparatuses for accommodating movement of any turbofan engine component during operation of the turbofan engine.

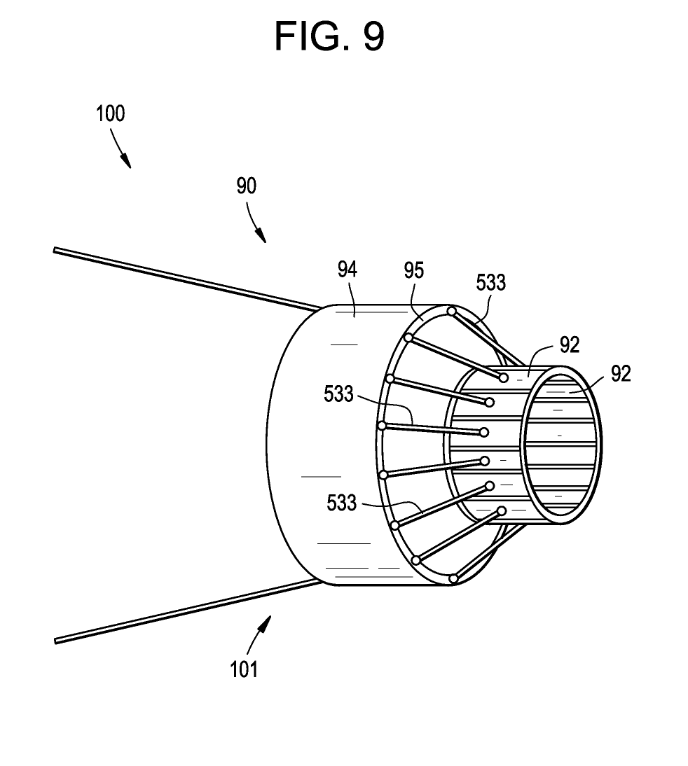

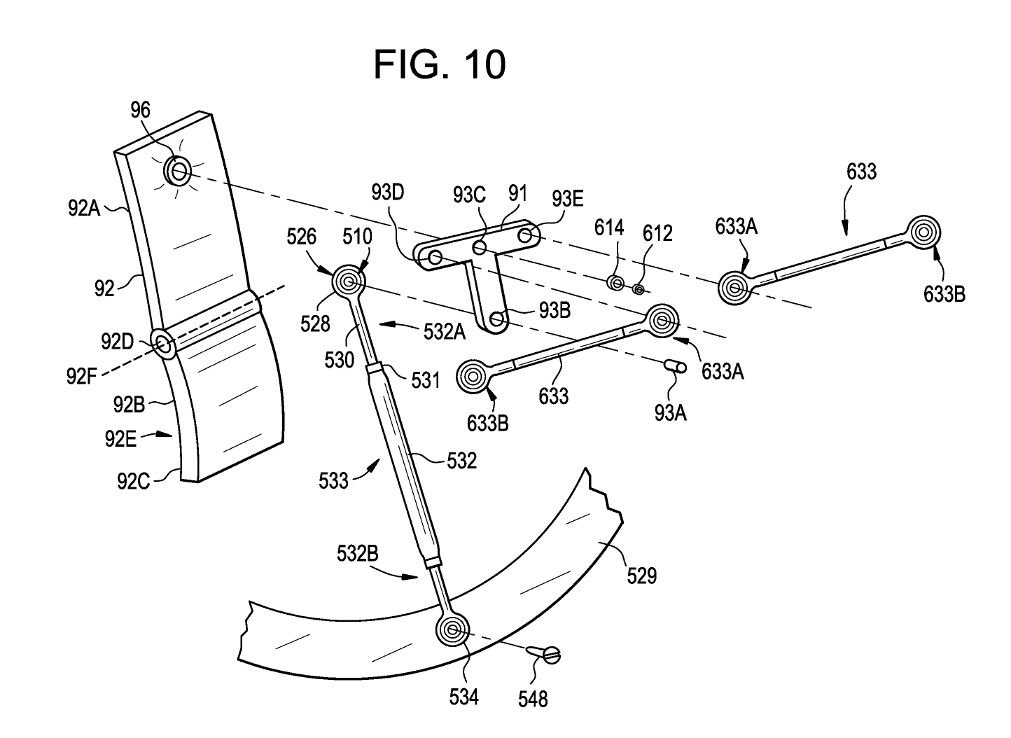

A plurality of linkage apparatuses 533 and 633 for actuation of a positioning device are depicted in FIGS. 9 and 10 and is similar to the linkage apparatus 33 shown in FIG. 2, the linkage apparatus 133 shown in FIG. 4, and the actuator 70 shown in FIG. 5, thus like elements are given a like element number preceded by the numerals 5 and 6.

As shown in FIG. 9, an augmentor 101 of a turbofan engine 100 includes a variable exhaust nozzle 90. The augmentor 101 is an afterburner installed on the turbofan engine 100, particularly a low-bypass turbofan engine, and is used to increase thrust for short periods of time during takeoff, climb, and flight. The variable exhaust nozzle 90 comprises a case or housing 94 and a plurality of independent panels or plates 92 that are pivotally connected to, or mounted on, an aft flange 95 of the housing 94 by at least one the linkage apparatuses 533. As shown in FIG. 10, one embodiment of the plate 92 comprises a first section 92A, a second section 92B pivotally connected to the first section 92A via a hinge section 92D such that the first and second sections 92A and 92B may rotate about an axis 92 F when the plate 92 is actuated by one or more of the linkage apparatuses 533 and/or 633. In addition, the second section 92B may define a flared section 92C at an aft end 92E of the plate 92.

Each of the linkage apparatuses 533, or connecting rods, comprises a positioning member 532 that defines a first end 532A and a second end 532B. The first end 532A of each positioning member 532 comprises a pivot member or socket 526 having a head portion 528 and a stem 530 extending therefrom that is removably secured or threadedly received in a receiving portion 531 of the positioning member 532. The socket 526 has a bearing assembly 510 swaged therein comprising a ball (not shown) defining a bore 516 therethrough (not shown), an outer race (not shown) and a liner (not shown) disposed between the ball 512 and the outer race 514.

The linkage apparatus 533 is pivotally connected to the plate 92 and a lever or a T-bracket 91, or like bracket, via the bearing assembly 510. A shaft or pin 93A extends through the bearing assembly 510 of the linkage apparatus 533 and is received within an aperture 93B formed in the T-bracket 91 as described above with reference to pivotally connecting the bearing assembly 10 to the mounting brackets 62A and 62B via a shaft or pin 36 extending through the bearing assembly 10, and the like, as depicted in FIG. 3. The present invention is not so limited as the socket 526 and the bearing assembly 510 of the linkage apparatus 533 can be pivotally connected directly to a receiving mounting 96 extending outwardly from the plate 92. A coupling member 534 or another socket (not shown) extends from the second end 533B of each of the linkage apparatuses 533 and is removeably and securely fastened to a structural member 529, namely, the aft flange 95 of the housing 94 of the variable exhaust nozzle 90, via fasteners 548 as described above with reference to removeably and securely fastening the mounting brackets 62A and 62B to the structural member 29 by fasteners 68 threadedly received within correspondingly tapped apertures in the structural member 29, and the like, as depicted in FIG. 3. The present invention is not so limited as the coupling member 534 of the linkage apparatus 533 can be pivotally connected to a linkage assembly (not shown) that is, in turn, removeably and securely fastened to the structural member 529.

In one embodiment, the T-bracket 91 is pivotally connected to the receiving mounting 96 extending outwardly from the plate 92 via a bearing assembly 610 received within an aperture 93C formed in the T-bracket 91 and the receiving mounting 96 as described above with reference to the bearing assembly 510 of the linkage apparatus 533.

One or more additional linkage apparatuses 633 may be employed to impart rotational movement to the T-bracket 91 about the bearing assembly 610 received within the receiving mounting 96 of the plate 92 and in relation to a structural member (not shown). Each of the linkage apparatuses 633 may comprise the linkage apparatus 33 (FIG. 2), the linkage apparatus 133 (FIG. 4) or the actuator 70 (FIG. 3). In one embodiment, a first end 633A of one of the linkage apparatuses 633 is pivotally connected to an aperture 93D formed in the T-bracket 91 via a bearing assembly (not shown). In another embodiment, a first end 633A of another one of the linkage apparatuses 633 is pivotally connected to an aperture 93E formed in the T-bracket 91 via a bearing assembly (not shown).

Referring to FIGS. 9 and 10, the aft ends 92E of the plates 92 can be made to diverge and converge upon the movement of the linkage apparatuses 533 operably coupled to each plate 92 and to variable exhaust nozzle 90. Movement of each of the linkage apparatuses 533 is effected via the T-bracket 91 rotatably mounted on the plate 92. The link apparatuses 533 are coupled to the T-bracket 91 and are operably connected to one or more actuators or linkage apparatuses 633 as described above. Moving the link apparatuses 533 via the actuator(s) 633 causes rotation of the lever the T-bracket 91, which in turn causes the respective link apparatus 533 to rotate about the point at which it is coupled to the variable exhaust nozzle 90, thereby causing the aft ends 92E of the plates 92 to diverge or converge.

One embodiment of the present invention comprises a high-cycle, short range-of-motion linkage apparatus is provided for actuation of a positioning device. The linkage apparatus includes a pivot member having a stem extending therefrom, a positioning member including a receiving portion into which the stem is removably secured, and at least one spherical plain bearing secured to the pivot member. The spherical plain bearing has an inner member having an outer engagement surface and a bore extending at least partway therethrough, an outer member positioned at least partially around the inner member, the outer member having an inner engagement surface contoured to a shape complementary to the outer engagement surface of the inner member, and a liner disposed between the inner engagement surface of the outer member and the outer engagement surface of the inner member, the liner comprising polytetrafluoroethylene and a phenolic resin reinforced with aramid fibers.

In one embodiment of the present invention, the outer member is swaged around the inner member. In another embodiment, the positioning member defines a first end and a second end, the positioning member first end defining the receiver portion into which the stem is removably secured, and the positioning member second end defining a coupling member. The positioning member is moveable between at least a first position and a second position.

In another embodiment of the present invention, the positioning member defines an actuator having a shaft extending therefrom and operable between an extended condition and a retracted condition to move the positioning member between the at least first position and second position. In another embodiment, the coupling member engages a structural member wherein the structural member is moveable between at least a first position and a second position respectively corresponding to the positioning member first and second positions.

In other embodiments, the structural member is a turbofan engine structural member and the spherical plain bearing engages a turbofan engine component linkage assembly. In one embodiment, the turbofan engine component linkage assembly defines a variable-stator-vane linkage assembly wherein the structural member first and second positions each define one of a substantially open air flow condition and a partially closed air flow condition. In another embodiment, the turbofan engine component linkage assembly defines a variable bypass valve assembly wherein the structural member first and second positions each define one of a partially open air flow condition and a closed air flow condition. In yet another embodiment, the turbofan engine component linkage assembly defines an oil and/or air cooler linkage assembly. In another embodiment, the turbofan engine component linkage assembly defines a variable exhaust nozzle plate linkage assembly.

In one embodiment of the present invention, the positioning member first and second end respectively define a first and a second receiver portion into which a first and a second stem is removably secured, and the positioning member first end is coupled to a variable exhaust nozzle plate and the positioning member second end is coupled to a variable exhaust nozzle. In another embodiment, a plurality of positioning members wherein the spherical plain bearing of each positioning member engages a turbofan engine component linkage assembly.

The swaged self-lubricating bearing assembly and linkage apparatus of the present invention provide an improvement over slot loader bearings or slotted entry bearings currently employed for the applications described herein such as, for example, for use within a turbofan engine.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of the appended claims.

What is claimed is:

1. A spherical plain bearing assembly, comprising:
a ball; and
an outer race positioned at least partially around an outer engagement surface of the ball, the outer race comprising,
an inner engagement surface contoured to a shape complementary to the outer engagement surface of the ball, and
a lubricous liner disposed on the inner engagement surface, the lubricious liner comprising polytetrafluoroethylene and a phenolic resin reinforced with aramid fibers;
wherein the outer engagement surface of ball is slidably and rotatably engaged with the inner engagement surface.

2. The spherical plain bearing assembly of claim 1 wherein the lubricous liner is formulated to withstand a high temperature environment.

3. The spherical plain bearing assembly of claim 2 wherein the high temperature environment defines a range from about 325° F. to about 600° F.

4. The spherical plain bearing assembly of claim 3 wherein the lubricous liner is formulated for high-cycle contact within a short range-of-motion.

5. A high-cycle, short range-of-motion linkage apparatus for actuation of a positioning device, the linkage apparatus comprising:
a pivot member having a stem extending therefrom;
a positioning member including a receiving portion into which the stem is removably secured; and
at least one spherical plain bearing secured to the pivot member, the spherical plain bearing comprising,
an inner member having an outer engagement surface and a bore extending at least partway therethrough,
an outer member positioned at least partially around the inner member, the outer member having an inner engagement surface contoured to a shape complementary to the outer engagement surface of the inner member, and
a liner disposed between the inner engagement surface of the outer member and the outer engagement surface of the inner member, the liner comprising polytetrafluoroethylene and a phenolic resin reinforced with aramid fibers.

6. The high-cycle, short range-of-motion linkage apparatus of claim 5 wherein the outer member is swaged around the inner member.

7. The high-cycle, short range-of-motion linkage apparatus of claim 6 wherein the positioning member defines a first end and a second end, the positioning member first end defining the receiver portion into which the stem is removably secured, and the positioning member second end defining a coupling member.

8. The high-cycle, short range-of-motion linkage apparatus of claim 7 wherein the positioning member is moveable between at least a first position and a second position.

9. The high-cycle, short range-of-motion linkage apparatus of claim 8 wherein the positioning member defines an actuator having a shaft extending therefrom and operable between an extended condition and a retracted condition to move the positioning member between the at least first position and second position.

10. The high-cycle, short range-of-motion linkage apparatus of claim 8 wherein the coupling member engages a structural member wherein the structural member is moveable between at least a first position and a second position respectively corresponding to the positioning member first and second positions.

11. The high-cycle, short range-of-motion linkage apparatus of claim 10 wherein the structural member is a turbofan engine structural member and the spherical plain bearing engages a turbofan engine component linkage assembly.

12. The high-cycle, short range-of-motion linkage apparatus of claim 11 wherein the turbofan engine component linkage assembly defines a variable-stator-vane linkage assembly wherein the structural member first and second positions each define one of a substantially open air flow condition and a partially closed air flow condition.

13. The high-cycle, short range-of-motion linkage apparatus of claim 11 wherein the turbofan engine component linkage assembly defines a variable bypass valve assembly wherein the structural member first and second positions each define one of a partially open air flow condition and a closed air flow condition.

14. The high-cycle, short range-of-motion linkage apparatus of claim 11 wherein the turbofan engine component linkage assembly defines an oil and/or air cooler linkage assembly.

15. The high-cycle, short range-of-motion linkage apparatus of claim 11 wherein the turbofan engine component linkage assembly defines a variable exhaust nozzle plate linkage assembly.

16. The high-cycle, short range-of-motion linkage apparatus of claim 15 wherein the positioning member first and second end respectively define a first and a second receiver portion into which a first and a second stem is removably secured, and the positioning member first end is coupled to a variable exhaust nozzle plate and the positioning member second end is coupled to a variable exhaust nozzle.

17. The high-cycle, short range-of-motion linkage apparatus of claim 11 further comprising a plurality of positioning members wherein the spherical plain bearing of each positioning member engages a turbofan engine component linkage assembly.
